(19) United States
(12) Patent Application Publication
(10) Pub. No.: US 2025/0130768 A1
(43) Pub. Date: Apr. 24, 2025

(54) MULTIPLE OPERAND FLOATING POINT ADDER WITH CORRECT ROUNDING

(71) Applicant: KALRAY, Montbonnot Saint Martin (FR)

(72) Inventors: Orégane DESRENTES, Montbonnot Saint Martin (FR); Benoît DUPONT DE DINECHIN, Grenoble (FR)

(21) Appl. No.: 18/491,998

(22) Filed: Oct. 23, 2023

(51) Int. Cl. G06F 7/485; G06F 5/01; G06F 7/24

(52) U.S. Cl. CPC G06F 7/485; G06F 5/012; G06F 7/24

(57) ABSTRACT

A hardware operator configured to add N+1 operands defined in a floating point format comprising a mantissa and an exponent, the operator comprising a sorting circuit configured to sort the operands in decreasing order of exponent, producing a sorted sequence of operands; an adder having N+1 compacted inputs, each compacted input having a width of at most N+1 consecutive bitfields, each bitfield having a width equal to a mantissa width plus a respective margin of bits; a shifter for each operand of the sorted sequence, configured to shift the mantissa of the operand by a respective right shift value on the corresponding compacted input of the adder; and a shift calculation circuit configured to calculate the right shift values so that the mantissas are positioned in corresponding bitfields of the adder inputs according to differences between the exponents. The shift calculation circuit is configured as a parallel prefix tree.

### TECHNICAL FIELD

The disclosure relates to hardware operators designed to perform dot products of large vectors having components in a floating point format, and more particularly to a multiple operand adder used in such operators.

### BACKGROUND

FIG. 1 is a generic schematic of a dot product operator with accumulation. The dot product operates on a vector X of N components (X₀, X₁ . . . . X_{N-1}) and a vector Y of N components (Y₀, Y₁ . . . . Y_{N-1}). The components, all in the same floating point format (for example FP16, FP32 or FP64 according to IEEE 754, or BF16 which is derived from FP32 by omitting 16 mantissa bits), are multiplied two by two. The N resulting products are summed with an operand Z_{N}, of a format that may differ from that of the components of the X and Y vectors, by an adder having N+1 inputs. The result of the addition is converted into a number R in the same format as the operand Z_{N} and is often fed back as the operand Z_{N} for an accumulation iteration.

One difficulty in such an operator lies in the design of the addition operator. It must sum signed numbers or products of numbers initially represented in a floating point format with a large dynamic range. Such a sum of terms can lead to catastrophic cancellation cases, namely the cancellation between terms with a large exponent leaving terms of smaller exponent that can lose precision or even disappear in intermediate rounding operations. It is therefore important that the adder operates at each stage on all the significant bits of the terms to perform a single rounding at the end, called “correct rounding” according to the specifications of the floating point number standards.

To keep the significant bits of all the terms, the floating point numbers are transformed into a fixed point representation having a number of bits equal to the dynamics of the floating point numbers. For example, an FP32 number having 24 mantissa bits and 8 exponent bits requires 280 bits in fixed point representation (256 bits given the 8-bit exponent dynamic range, plus the 24 mantissa bits). The products of FP32 numbers processed by the adder have a 48-bit mantissa and a 9-bit exponent and require 560 bits in fixed point representation. When a multitude of such products is to be added, the number of bits to process in parallel becomes unreasonable in terms of silicon area.

To nevertheless benefit from fixed point representations, advantage is taken of the fact that all bits of a floating point number, except those of the mantissa, are not significant. For example, for a product of FP32 numbers, 512 bits are not significant out of the 560 of the representation, distributed in front and behind the 48-bit mantissa. For positive numbers, the nonsignificant bits are bits at 0 in front of and behind the mantissa, while for negative numbers, the non-significant bits are at 1 in front of the mantissa and 0 behind the mantissa. Techniques have thus been proposed to operate only with the mantissa bits by removing the “useless” nonsignificant bits between two mantissas. Since the final result is often a number in the same format as the input operands (e.g. FP32), only the most significant bits remaining in the fixed point representation of the addition result are taken into account in the final result. All the other lower weight bits, which are still present, are used to refine the rounding of the final result, namely to provide a “correct rounding”. Performing a correct rounding is important to limit rounding errors when the result is fed back into the operator over a large number of iterations.

Even though a large number of the bits that are kept in the intermediate operations according to these techniques do not contribute to the final result, it is important to keep them all until the final rounding operation to anticipate mutual cancellations and to generate the “sticky bit” according to the IEEE 754 standard, which is a flag set to 1 by the operator when the exact result before rounding has at least one bit at 1 behind the bits used for rounding.

The paper [Yao Tao et al., “Correctly Rounded Architectures for FloatingPoint Multi-Operand Addition and Dot-Product Computation”, IEEE ASAP 2013] presents a technique for adding multiple floating point operands while performing correct rounding. This technique uses a compaction of the fixed point representations of the terms to remove useless nonsignificant bits. In summary, the mantissas of the terms are aligned with respect to each other on respective inputs of an integer adder according to the differences between the exponents and so that the mantissas follow each other as closely as possible. If the adder has N inputs, the width of each input is on the order of N times the width of a mantissa, plus a margin of a few bits per mantissa.

One difficulty with this type of structure lies in optimizing the calculation of the respective shifts to be applied to the mantissas.

### SUMMARY

A hardware operator configured to add N+1 operands defined in a floating point format comprising a mantissa and an exponent, the operator comprising a sorting circuit configured to sort the operands in decreasing order of exponent, producing a sorted sequence of operands; an adder having N+1 compacted inputs, each compacted input having, starting from a most significant bit, a width of at most N+1 consecutive bitfields, each bitfield having a width equal to a mantissa width plus a respective margin of bits; a shifter for each operand of the sorted sequence, configured to shift the mantissa of the operand by a respective right shift value on the corresponding compacted input of the adder; and a shift calculation circuit configured to calculate the right shift values so that the mantissas are positioned in corresponding bitfields of the adder inputs according to differences between the exponents. The shift calculation circuit is configured as a parallel prefix tree implementing the relation:

$${S}_{i} = {min}_{j ∈ [ 0 , i ]} ( {d}_{j} + {p}_{j} + {E}_{j}^{*} ) - {E}_{i}^{*}$$

where Sᵢ is the right shift value for the mantissa of operand i of the sorted sequence,

Eᵢ* is the exponent of operand i of the sorted sequence,

dⱼ is a start position in bits of bitfield j of the corresponding compacted input of the adder, defined from the most significant bit of the compacted input, and

pⱼ defines the bit margin for bitfield j of the compacted input.

The shift calculation circuit may comprise, for an operand of rank i of the sorted sequence: an adder producing the sum dᵢ+pᵢ+Eᵢ*; a minimum value selection tree connected to select the minimum value among the current sum and the sums produced for the previous operands in the sorted sequence; and a subtractor producing the right shift value Sᵢ as the difference between the output of the minimum value selection tree and the exponent Eᵢ*.

### BRIEF DESCRIPTION OF THE DRAWINGS

Embodiments will be described in the following description, made by way of non-limiting example in connection with the accompanying drawings in which:

FIG. 1 is a general schematic diagram of a conventional hardware operator performing a dot product of two vectors with an accumulation;

FIG. 2 is a block diagram of a multiple operand floating point adder performing correct rounding;

FIG. 3 represents an example of the structure of the adder inputs;

FIG. 4 illustrates exemplary shifts applied to mantissas on the adder inputs; and

FIG. 5 is an architecture of an embodiment of a shift calculation circuit.

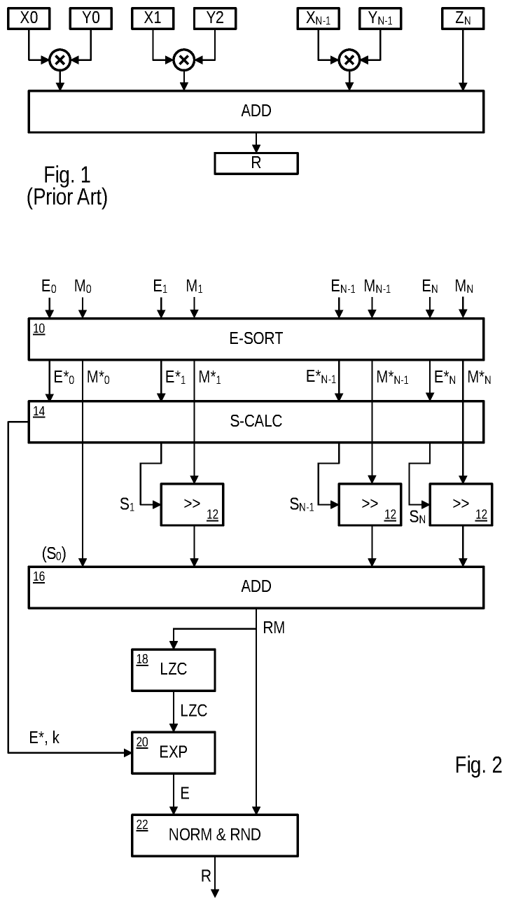

### DETAILED DESCRIPTION

FIG. 1 is a block diagram illustrating an adder with N+1 floating point inputs adapted from the structures described by Yao Tao in the aforementioned IEEE ASAP 2013 paper. The inputs receive floating point operands (Eᵢ, Mᵢ), where Eᵢ and Mᵢ are the exponent and mantissa of the operand of rank i, with i ranging from 0 to N.

Note that the operands are generally signed, with a sign bit being the most significant bit of the mantissa. When the sign is positive (sign bit at 0), the non-significant bits in front of and behind the mantissa are 0. When the sign is negative, the non-significant bits in front of the mantissa are 1 and those behind are zero. For sake of clarity, the non-significant bits are assumed to be 0, knowing that the situation is reversed for negative numbers.

A sorting circuit 10 receives the operands (Eᵢ, Mᵢ) and sorts them in decreasing order of exponent (E), producing a sorted sequence of operands (E*ᵢ, M*ᵢ). When multiple operands have the same exponent, they are placed relative to each other in an arbitrary order in the sequence, the order being unimportant in this case.

The sorted operand mantissas M*ᵢ are provided to respective right shift circuits 12, while the exponents E*ᵢ are provided to a shift calculation circuit 14 for calculating the respective shift commands Sᵢ to be applied to the shifters 12. The shifters are configured to shift the mantissas from a common origin corresponding to the most significant bit of a compacted fixed point representation defined below. This fixed point representation starts with the mantissa M*₀ of the first operand in the sorted sequence, namely the operand with the highest exponent. Thus, the shift S₀ to be applied to it is fixed and hardwired, as indicated in the figure by (S₀).

The shifters 12 and calculation circuit 14 perform a compaction function described in more detail below.

Each shifted mantissa is provided to a respective input of an integer adder 16 whose inputs form compacted fixed point representations. The inputs are added in a traditional way to produce a result RM in the same compact format as the inputs. Given the structure of the adder's inputs and the corresponding mantissa shift operations, the result RM is ready to be processed in a traditional way to produce a floating point number according to the standards.

In particular, a circuit 18 determines the number of leading zeros LZC (“Leading Zero Count”) in the result RM.

A calculation circuit 20 determines the exponent E of the result from the LZC value and information from the shift calculation circuit 14.

Finally, a normalization and rounding circuit 22 provides the final rounded result R in the desired floating point format from the result RM provided by the adder 16 and the exponent E.

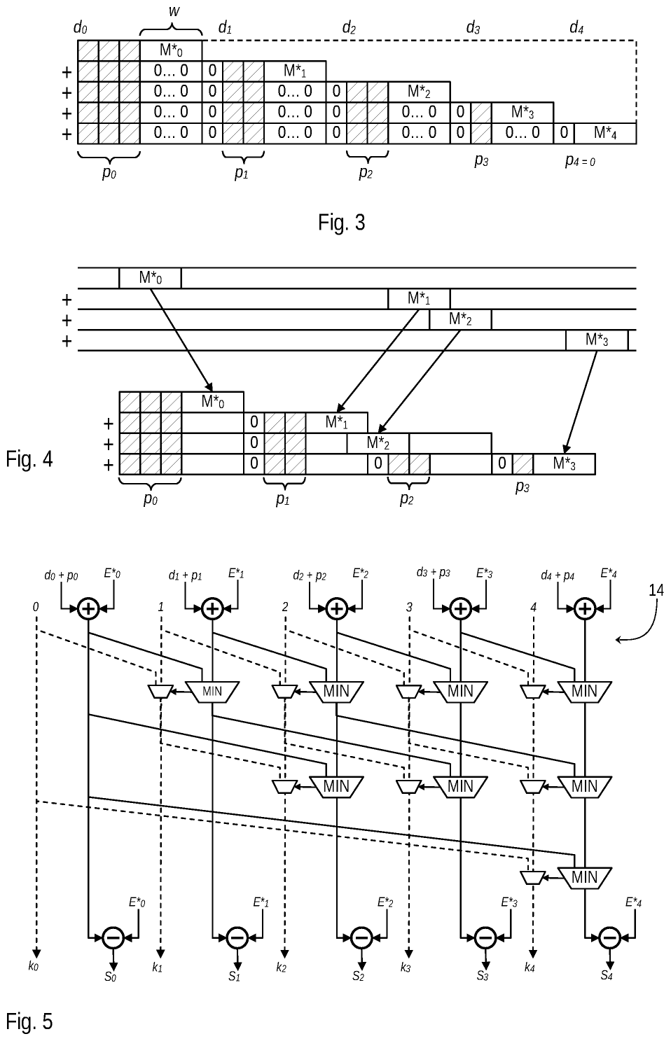

FIG. 3 represents an exemplary input structure of the adder 16, in an example where N=4. Each input is divided into N+1 consecutive fields defined by start positions do to dx referenced to the most significant bit of the input. Each field is designed to contain a mantissa with a number p of leading carry bits and a 0 bit on the right. A field unoccupied by a mantissa has all its bits at 0.

The number of carry bits p may be common to all fields and set to a worst case value. Preferably, a field of rank i is assigned a number of carry bits pᵢ equal to the value log₂(N−i+1) rounded up to the next integer.

In summary:

$${p}_{i} = ⌈ {log}_{2} ( N - i + 1 ) ⌉$$

$${d}_{0} = 0$$

$${d}_{i} = {d}_{i - 1} + w + 1 + {p}_{i - 1}$$

where w is a mantissa width.

In the case where the precision format of the result R is lower than that of the operands, w is equal to the mantissa width of the operands. In the case where the precision format of the result R is higher than that of the operands, w is equal to the mantissa width of result R plus 2.

The notation “┌x┐” means that the value x is rounded up to the next integer.

FIG. 3 illustrates the desired field filling in a particular case where the exponents of the sorted operands are sufficiently spaced apart so that no mantissa influences another mantissa in the sum. Then, as shown, each mantissa is placed in the field having the same rank as the mantissa in the sorted list. FIG. 3 also corresponds to a case of maximum occupancy of the adder inputs and reveals that an input of rank i only needs fields of ranks 0 to i. By designing the adder accordingly, substantial savings are achieved in elemental adders and shifters for the unused bits of the inputs.

FIG. 4 illustrates a situation where some mantissas have exponents close enough to influence each other in the sum. The top of the figure is a full fixed point representation of the first four operands. The bottom is the corresponding compacted representation at the adder inputs.

The mantissa M*₀, with the highest exponent, is systematically placed in field 0. Mantissas M*₁ and M*₂ have close exponents, so they overlap. Mantissa M*₁ is placed in its corresponding field 1. However, mantissa M*₂ is placed relative to mantissa M*₁ according to the exponent difference, to maintain the relative positioning of these mantissas from the full fixed point representation. Mantissa M*₂ is thus placed ahead of its corresponding field 2, overlapping the margin of bits formed by the carry bits p₂ of field 2 and the 0 bit provided at the end of field 1. Field 2 is merged with field 1 into a single wider field.

Mantissa M*₃ has an exponent sufficiently distant from the exponent of the previous mantissa M*₂. It can be placed in its corresponding field 3. The appropriate placement of the mantissas on the adder inputs is determined by the calculation of the shifts Sᵢ by circuit 14. In the general case where mantissas overlap or are close enough to influence each other in the sum, the calculation of a shift Sᵢ is recursive. In other words, the calculation of a shift Sᵢ involves i steps, as shown by an exemplary iterative algorithm in Figure 3 of Yao Tao's paper. Thus, an addition of N+1 numbers would require N steps to calculate the last shift S_{N}. Therefore, an implementation using a combinational logic circuit involves in principle a critical path of N logic gates.

In the present disclosure, a shift calculation technique is proposed that can be implemented by a combinational logic circuit with a critical path of only ┌log₂(N+1)┐ gates. This technique is based on the following relationship developed for expressing the shifts Sᵢ:

$${S}_{i} = {min}_{j ∈ [ 0 , i ]} ( {d}_{j} + {p}_{j} + {E}_{j}^{*} ) - {E}_{i}^{*} ,$$

This relationship is well suited for an implementation using a parallel prefix tree.

FIG. 5 depicts a shift calculation circuit 14 in more detail, including an embodiment of a parallel prefix tree for an adder with 5 inputs (N=4), as an example. The tree comprises five branches associated with ranks 0 to 4 respectively. A branch of rank j starts with an adder calculating the sum dᵢ+pⱼ+E*ⱼ. Each branch i terminates with a subtractor that subtracts the exponent E*ᵢ from the branch output to produce the corresponding shift Sᵢ.

Elementary minimum value selection circuits MIN are interspersed in stages in the branches to form a minimum value selection tree, with the number of stages at most equal to ┌log₂(N+1)┐. More specifically, branch i has at most ┌log₂(i+1)┐ stages of MIN circuits. Each MIN circuit receives the upstream branch value and a value from a preceding branch. The circuit forwards the minimum of its two inputs downstream on the current branch.

As shown, a first stage is formed by MIN circuits placed in branches 1 to 4. Their connection is regular in that each MIN circuit receives the input value of the current branch and the input value of the previous branch.

A second stage is formed by MIN circuits placed in branches 2 to 4. Their connection is also regular in that each MIN circuit of this stage receives the value from the first stage of the current branch and the value from the first stage of the branch two positions before (or the input value of the branch two positions before if it has no first stage).

The third stage includes a single MIN circuit in branch 4, which receives the value from the second stage of the current branch and the value of branch 0. Other connection possibilities exist for the MIN circuit of this stage—it is sufficient to connect its second input to any other MIN circuit that receives directly or indirectly the value of branch 0. This second input can therefore be connected downstream from any of branches 1 to 3.

In general, it is sufficient to connect the MIN circuits of a given branch so that all these MIN circuits receive on the left directly or indirectly all the input values of the previous branches. To reduce the critical path, it is preferable to take the values from the previous branches as far left as possible, as shown.

The exponents E*ⱼ as well as a set of adjusted indices kᵢ associated with the respective mantissas M*ᵢ are used by circuit 20 to calculate the exponent E. An index kᵢ is the rank of the field in which mantissa M*ᵢ is placed, nominally equal to i. When fields are merged because mantissas overlap, these fields all receive indexes equal to that of the first merged field, and the corresponding indexes are qualified as “adjusted”.

For example, in the case of FIG. 4, the adjusted index k₂ of mantissa M*₂ is equal to 1 instead of 2, while the adjusted index k₃ of mantissa M*₃ does not change and is equal to 3.

In general, the adjusted index kᵢ is equal to i when Sᵢ=dᵢ+pᵢ and is equal to kᵢ₋₁ otherwise.

The exponent calculation circuit 20 determines the exponent E according to the following cases.

$$If$$

$$LZC < {d}_{1}$$

$$then$$

$$E = {E}_{0}^{*} + 1 - ( LZC - ( {d}_{0} + {p}_{0} ) ) .$$

This is the case where the operand with the highest exponent is not canceled by another operand with the same exponent.

$$If$$

$$LZC ∈ [ {d}_{i} , {d}_{i + 1} - 1 ]$$

$$then$$

$$E = {E}_{{k}_{i}}^{*} + 1 - ( LZC - ( {d}_{{k}_{i}} + {p}_{{k}_{i}} ) ) .$$

In this case, the operand with the highest exponent was canceled, and the exponent is determined based on the first following field containing significant bits. The value i is the rank of this first following field. The adjusted index kᵢ is used instead of index i to account for the case where leading bits are canceled in overlapping mantissas.

In the particular case where LZC=d_{N+1}, the result R is 0. The value d_{N+1}, which indicates the position of a nonexistent field that would follow the last field of the adder inputs, is in fact the size of the adder inputs. There is no need to calculate the exponent.

The selection tree of FIG. 5 may also be used to provide the adjusted indexes kᵢ via dotted line paths following the same tree structure, formed of branches receiving 0 to 4 respectively as inputs, i.e., the branch ranks. These inputs are switched by multiplexers controlled by the selection states of the corresponding MIN circuits. Each multiplexer controlled by the last MIN circuit of a branch provides the adjusted index of the branch.

1. A hardware operator configured to add N+1 operands defined in a floating point format comprising a mantissa and an exponent, the operator comprising:
a sorting circuit configured to sort the operands in decreasing order of exponent, producing a sorted sequence of operands;
an adder having N+1 compacted inputs, each compacted input having, starting from a most significant bit, a width of at most N+1 consecutive bitfields, each bitfield having a width equal to a mantissa width plus a respective margin of bits;
a shifter for each operand of the sorted sequence, configured to shift the mantissa of the operand by a respective right shift value on the corresponding compacted input of the adder; and
a shift calculation circuit configured to calculate the right shift values so that the mantissas are positioned in corresponding bitfields of the adder inputs according to differences between the exponents;
wherein the shift calculation circuit is configured as a parallel prefix tree implementing a relation:
$${S}_{i} = {min}_{j ∈ [ 0 , i ]} ( {d}_{j} + {p}_{j} + {E}_{j}^{*} ) - {E}_{i}^{*} ,$$
where Sᵢ is a right shift value for the mantissa of operand i of the sorted sequence,
Eᵢ* is an exponent of operand i of the sorted sequence,
dⱼ is a start position in bits of bitfield j of the corresponding compacted input of the adder, defined from the most significant bit of the compacted input, and
pⱼ defines a bit margin for bitfield j of the compacted input.

2. The operator according to claim 1, wherein the shift calculation circuit comprises, for an operand of rank i of the sorted sequence:
an adder producing a sum dᵢ+pᵢ+Eᵢ*;
a minimum value selection tree connected to select the minimum value among a current sum and the sums produced for previous operands in the sorted sequence; and
a subtractor producing the right shift value Sᵢ as the difference between an output of the minimum value selection tree and an exponent Eᵢ*.

3. The operator according to claim 1, wherein the bit margin pᵢ for bitfield i is at least equal to a value log₂(N−i+1) rounded up to a next integer, and the start position dᵢ of bitfield i is expressed by:
$${d}_{i} = {d}_{i - 1} + w + 1 + {p}_{i - 1} ,$$
where d₀=0 and w is a mantissa width.

4. The operator according to claim 2, wherein the minimum value selection tree comprises stages of elementary minimum value selection circuits, each elementary minimum value selection circuit configured to perform a selection between two input values, the elementary minimum value selection circuits being connected so that a number of stages is at most equal to a value log₂(N+1) rounded up to a next integer.

5. The operator according to claim 4, wherein the elementary minimum value selection circuits are further connected such that a branch associated with an operand of rank i of the sorted sequence has a number of stages at most equal to a value log₂(i+1) rounded up to the next integer.

6. The operator according to claim 1, wherein the compacted input of rank i of the adder has a physical width of at most i+1 bitfields plus the respective bit margins starting from the most significant bit.

7. The operator according to claim 5, further comprising, for each branch of the parallel prefix tree, an adjusted index selection tree having the same structure as the corresponding minimum value selection tree,
the adjusted index selection tree including index selection circuits controlled respectively by the elementary minimum value selection circuits, wherein inputs of the branches of the adjusted index selection tree are the ranks of the branches.

8. The operator according to claim 7, comprising an exponent calculation circuit configured to determine the exponent of a result based on the exponents of the operands of the sorted sequence, a number of leading zeros leading a first significant bit of an addition result, and indexes produced by the adjusted index selection trees.
